(19) United States
(12) Patent Application Publication
(10) Pub. No.: US 2009/0195912 A1
(43) Pub. Date: Aug. 6, 2009

(54) DISK DRIVE THAT CALIBRATES THE POWER FOR SETTING THE DYNAMIC FLY HEIGHT OF THE HEAD TO A TARGET VALUE

(75) Inventor: Takumi SATO, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/248,757

(22) Filed: Oct. 9, 2008

(30) Foreign Application Priority Data
Jan. 31, 2008 (JP) 2008-021412

(51) Int. Cl. G11B 21/02

(52) U.S. Cl. 360/75

(57) ABSTRACT

According to one embodiment, a measuring module measures the dynamic flying height of a head. A change calculation module calculates a change ΔDFHPt in a reference power optimal for setting a first dynamic flying height, based on the difference between a second dynamic flying height, which has a value measured by the measuring module while the reference power is being supplied to a adjusting element, and the first dynamic flying height. A controller changes the power to be supplied to the adjusting element, by the change ΔDFHPt calculated by the change calculation module.

### CROSS-REFERENCE TO RELATED APPLICATIONS

This application is based upon and claims the benefit of priority from Japanese Patent Application No. 2008-021412, filed Jan. 31, 2008, the entire contents of which are incorporated herein by reference.

### BACKGROUND

1. Field

One embodiment of the invention relates to a disk drive in which the power supplied to an adjusting element is controlled, thereby to adjust the dynamic flying height of the head (magnetic head). For example, the embodiment relates to a disk drive that can calibrate the power for setting the dynamic fly height of the head to a target value and also to a calibration method that is fit for use in such a disk drive.

2. Description of the Related Art

Disk drives (e.g., magnetic disk drives) having an actuator that can adjust the dynamic flying height (DFH) of the head have been hitherto known. The actuator has a slider that holds the head (magnetic head). The actuator supports the slider and can move the slider in the radial direction of the disk (magnetic disk). As generally defined, the dynamic flying height of the head is the distance between the head and the disk (more precisely, the surface of the disk, i.e., disk surface).

Actuators that can adjust the dynamic flying height of the head are disclosed in, for example, Jpn. Pat. Appln. KOKAI Publication No. 2007-293948 (first prior-art document) and Jpn. Pat. Appln. KOKAI Publication No. 2007-179723 (second prior-art document). More specifically, the first and second prior-art documents disclose a thermal actuator, a piezoelectric actuator, etc. A part of such an actuator can be deformed to adjust the dynamic flying height of the head.

The thermal actuator, for example, has its slider deformed through thermal expansion. Used as a heat source (adjusting element) that achieves the thermal expansion is a heater (resistive heating element). The heater is arranged at that part of the slider which lies near the head. In the thermal actuator, the power supplied to the heater is controlled, varying the thermal expansion of the slider (head). The dynamic flying height of the head is thereby adjusted.

The piezoelectric actuator has a slider, a suspension and a piezoelectric element. The suspension supports the slider. The piezoelectric element is arranged on the slider (or on the suspension). A voltage applied to the piezoelectric element is controlled, adjusting the deformation of the slider. The dynamic flying height of the head is thereby adjusted. That is, the piezoelectric actuator uses a piezoelectric element as an element for adjusting the dynamic flying height of the head.

The condition of setting the dynamic flying height of the head (e.g., power, current, or voltage) changes with time as the magnetic disk drive operates. Jpn. Pat. Appln. KOKAI Publication No. 2004-14092 (third prior-art document), for example, discloses a scheme of setting the dynamic flying height of the head to a target value. This scheme is characterized in that the dynamic flying height is measured and if the difference between the height measured and the target value falls outside a tolerant range, the height-setting condition (more precisely, voltage applied) is repeatedly changed until that difference falls within the tolerant range.

The third prior-art document does not describe any timing at which to perform the calibration to set the dynamic flying height of the head to the target value (dynamic flying-height calibration). Nonetheless, the calibration should be performed preferably when the disk drive is activated, because the condition of setting the dynamic flying height of the head changes with time as the magnetic disk drive operates.

In the calibration (calibration method) described in the third prior-art document, however, whether the difference between the height measured and the target value falls outside a tolerant range must be repeatedly determined, while the height-setting condition (i.e., voltage applied) is repeatedly changed. Inevitably, the time required to activate the disk drive will increase if such calibration as described in the third prior-art document is performed every time the disk drive is activated.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is an exemplary block diagram showing the configuration of a magnetic disk drive according to an embodiment of the invention;

FIG. 2 is an exemplary block diagram showing the calibration module shown in FIG. 1 and some components peripheral to the calibration module;

FIG. 3 is an exemplary flowchart showing the sequence of determining the reference power in the embodiment; and

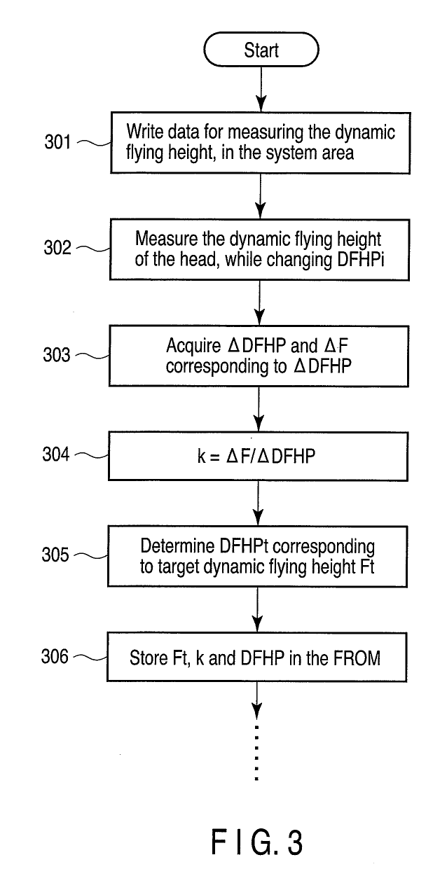

FIG. 4 is an exemplary flowchart showing the sequence of the calibration performed in the embodiment.

### DETAILED DESCRIPTION

Various inventions according to the invention will be described hereinafter with reference to the accompanying drawings. In general, according to one embodiment of the invention, there is provided a disk drive that comprises: an adjusting element configured to adjust a dynamic flying height of a head in accordance with power supplied; a measuring module configured to measure the dynamic flying height of the head; a change calculation module configured to calculate a change ΔDFHPt in a reference power optimal at present for setting a first dynamic flying height, based on a difference between a second dynamic flying height, which has a value measured by the measuring module while the reference power is being supplied to the adjusting element, and the first dynamic flying height; and a controller configured to change the power to be supplied to the adjusting element, by the change ΔDFHPt calculated by the change calculation module for the reference power.

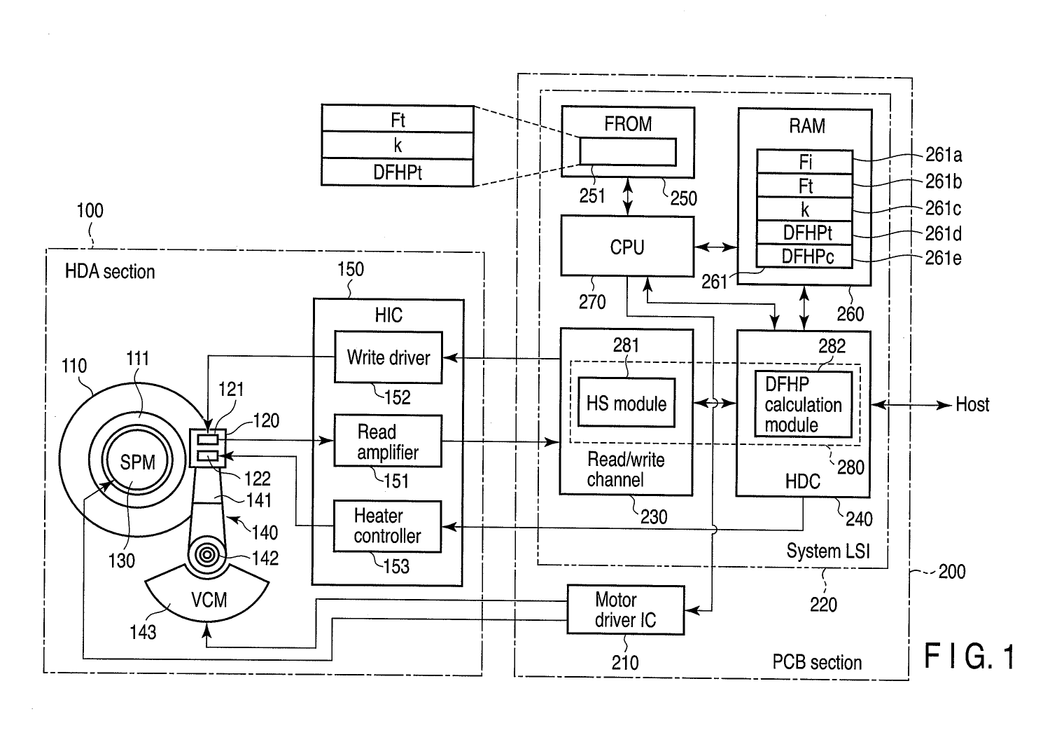

FIG. 1 is a block diagram showing a magnetic disk drive (HDD) according to an embodiment of the invention. The HDD comprises two main sections, i.e., a head-disk assembly (HDA) section 100 and a printed-circuit board (PCB) section 200.

The HDA section 100 is the main unit of the HDD. It has a disk (magnetic disk) 110, a spindle motor (SPM) 130, an actuator 140, and a head IC (HIC) 150. The disk 110 has two disk surfaces, i.e., upper disk surface and lower disk surface. The upper disk surface, for example, is a recording surface in which data may be magnetically recorded. On the recording surface, a number of concentric tracks (not shown) are arranged. Of these tracks, a prescribed number of inner tracks constitute an area allocated as a system area 111, which is dedicated to the system only. The SPM 130 can rotate the disk 110 at high speed.

The actuator 140 has a slider (magnetic-head slider) 120. The slider 120 is arranged over the recording surface of the disk 110. As the disk 110 is rotated, the slider 120 flies above the disk 110. The slider 120 includes a head (magnetic head) 121 and a heater 122. The head 121 is a composite head that has a read-head element and a write-head element. The head 121 is used to write data in, and read data from, the disk 110.

Note that the lower disk surface is a recording surface, too. Above this recording surface, a slider similar to the slider 120 is arranged. The configuration of FIG. 1 is an HDD having only one disk 110. The HDD may have a plurality of disks 110 stuck one above another.

The heater 122 is a resistive heating element. When supplied with power (current), the heater 122 generates heat. The heat thus generated thermally expands a part of the slider 120 (i.e., head 121). That is, the heater 122 is the element that adjusts the distance between the head 121 and the recording surface of the disk 110, i.e., the dynamic flying height of the head 121.

The actuator 140 is a thermal actuator. The actuator 140 has a suspension arm 141, a pivot 142, and a voice coil motor (VCM) 143, in addition to the slider 120. The suspension arm 141 supports the slider 120. The pivot 142 supports the suspension arm 141, allowing the arm 141 to rotate freely. The VCM 143 is a drive source for the actuator 140. The VCM 143 exerts a torque on the suspension arm 141 so that the slider 120 may move in the radial direction of the disk 110. When the slider 120 is so moved, the head 121 is positioned at the target track of the disk 110.

The SPM 130 and the VCM 143 are driven with drive currents (SPM current and VCM current) supplied from a motor driver IC 210, which will be described later. The head 121 and the heater 122 are connected to the HIC 150. The HIC 150 is secured to a specified part of the actuator 140 and is electrically connected to the printed-circuit board section (PCB) section 200 by a flexible printed circuit (FPC). In FIG. 1, however, the HIC 150 is shown at a position remote from the actuator 140, for convenience of illustration. Note that the HIC 150 may be fixed to the PCB section 200.

The HIC 150 is a single-chip IC that includes a read amplifier 151, a write driver 152, and a heater controller 153. The read amplifier 151 amplifies any signal (read signal) that the head 121 has read. The write driver 152 receives a write data from a read/write channel 230 (more precisely, write channel 232 incorporated in the channel 230), which will be described later, and converts the write data to a write current. This write current is output to the head 121.

The heater controller 153 supplies the heater 22 with power (hereinafter called DFH power) the value of which has been designated by a CPU 270 that will be described later. In this embodiment, the value of the DFH power which the heater controller 153 supplies to the heater 122 is designated by setting a parameter (DFH-power parameter) in the dedicated register (not shown) that is incorporated in the head IC 150. The parameter is set in the dedicate register by the CPU 270 via an HDC 240, which will be described later.

The PCB section 200 comprises mainly a motor driver IC 210 and a system LSI 220. The motor driver 210 drives the SPM 130 and the VCM 143. More specifically, the motor driver IC 210 drives the SPM 130 at a constant speed. Further, the motor driver IC 210 supplies a current (VCM current) designated by the CPU 270 to the VCM 143, thus driving the actuator 140.

The system LSI 220 is an LSI called “system on chip (SOC)” that comprises a read/write channel 230, a disk controller (HDC) 240, a flash ROM (FROM) 250, a RAM 260, and a CPU 270, all integrated together in a single chip. The read/write channel 230 is a signal-processing device that processes signals related to read/write operation. The read/write channel 230 is connected to the HIC 150 incorporated in the HDA section 100.

The HDC 240 is connected to a host (host system), the read/write channel 230, the RAM 260 and the CPU 270. The host uses the HDD as an external storage apparatus. The host is a digital apparatus such as a personal computer. The HDC 240 has host-interface control function of receiving commands (e.g., write command, read command, etc.) transferred from the host and transferring data between the host and the HDC 240. The HDC 240 also has disk-interface control function of transferring data between the disk 110 and the HDC 240 through the read/write channel 230.

The FROM 250 is a nonvolatile memory in which data can be rewritten. The FROM 250 stores a control program (firmware program). Using this control program, the CPU 270 controls the HDD. Part of the storage area provided in the FROM 250 is used as dynamic-flying height management area (DFH management area) 251. The DFH management area 251 is provided to store, for example, three values (parameters) Ft, k and DFHPt that are indispensable for controlling the dynamic flying height of the head 121.

“Ft” is a target dynamic flying height (first dynamic flying height) set for the head 121. The dynamic flying height set for the head 121 in this embodiment is not an absolute value, but is a relative value that is proportional to the absolute value.

“k” is a coefficient (proportionality constant) representing the ratio of a change in the dynamic flying height of the head 121 to the change in the DFH power (DFHP). In other words, the coefficient k represents how readily the dynamic flying height of the head 121 changes in response to the change in the DFH power. The coefficient k is given by the following equation:

k=ΔF/ΔDFHP (1)

where ΔDFHP is a change in the DFH power, and ΔF is a change in the dynamic flying height of the head 121 undergoes when the DFH power changes by ΔDFHP.

DFHPt is the DFH power (reference DFH power) indispensable for achieving the above-mentioned first dynamic flying height Ft. Note that k and DFHPt are acquired during the manufacture of the HDD.

The RAM 260 is a volatile memory in which data can be rewritten. A part of the storage area of the RAM 260 is used as a write buffer for temporarily storing the data (write data) to be written in the disk 110 through the HDC 240. Another part of the storage area of the RAM 260 is used as a read buffer for temporarily storing the data (read data) read from the disk 110 through the read/write channel 230. A further part of the storage area of the RAM 260 is used as a register file 261. The register file 261 includes registers 261a to 261e. The register 261a is used to hold the data representing the dynamic flying height measured most recently of the head 121. The registers 261b, 261c and 261d are used to hold Ft, k and DFHPt, respectively. The register 261e is used to hold the optimal DFH power (DFHPc) for achieving the first dynamic flying height Ft.

The CPU 270 is the main control module of the HDD. The CPU 270 controls some other components of the HDD in accordance with the control programs stored in the FROM 250.

In this embodiment, a calibration module 280 is provided partly in the read/write channel 230 and partly in the HDC 240. The calibration module 280 includes a harmonic sensor module (HS module) 281 and a DFH-power calculation module (DFHP calculation module) 282. The HS module 281 is provided in the read/write channel 230. The DFHP calculation module 28 is provided in the HDC 240.

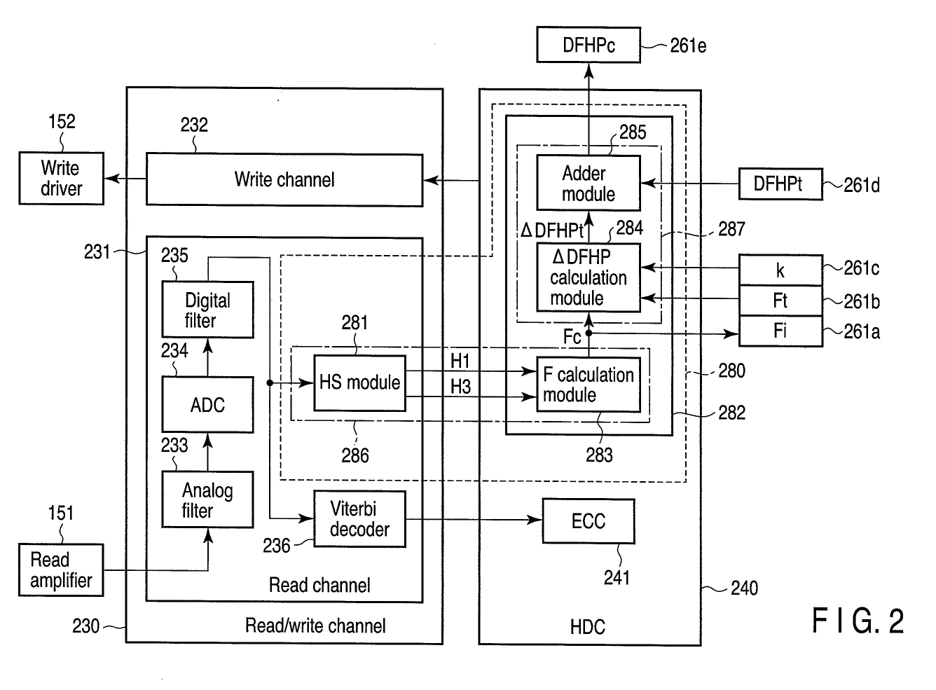

FIG. 2 is a block diagram showing the calibration module 280 shown in FIG. 1 and some components peripheral to the calibration module 280. As shown in FIG. 2, the read/write channel 230 includes a read channel 231 and a write channel 232. The read channel 231 has a circuit configuration known in the art which can process any read signal that has been read by the head 121 and amplified by the read amplifier 151. More precisely, the read channel 231 has an analog filter 233, an analog/digital converter (ADC) 234, a digital filter 235, and a viterbi decoder 236.

The analog filter 233 is used to remove high-frequency noise from the read signal amplified by the read amplifier 151. The ADC 234 converts the signal (i.e., read signal) output from the analog filter 233 to digital data, which is input to the digital filter 235. The digital filter 235 performs waveform equalization on the data output from the ADC 234. This waveform equalization is adapted to data of the partial-response class. From the output of the digital filter 235, the viterbi decoder 236 detects the data item of the highest likelihood and decodes the data item and generates data such as a non-return-to-zero (NRZ) code.

The read channel 231 includes an HS module 281. The HS module 281 detects, from the output of, for example, the digital filter 235, the amplitude H1 of a first harmonic wave and the amplitude H3 of a third harmonic wave, which are indispensable to the measuring of the dynamic flying height Fi of the head 121.

The HDC 240 includes an error-correcting circuit (ECC) 241. The ECC 241 corrects the error in the data generated by the viterbi decoder 236 incorporated in the read channel 231, on the basis of the error-correcting code that is added to the data.

The HDC 240 includes a DFHP calculation module 282. The DFHP calculation module 282 constitutes the calibration module 280, jointly with the HS module 281 that is provided in the read channel 231. The HS module 281 may be provided in the HDC 240 instead of the read channel 231.

The DFHP calculation module 282 includes a dynamic-flying height calculation module (F calculation module) 283, a DFHP-change calculation module (ΔDFHP calculation module) 284, and an adder module 285. The F calculation module 283 calculates the dynamic flying height of the head 121 from the amplitudes H1 and H3 of the first and third harmonic waves the HS module 281 has detected. The HS module 281 and the F calculation module 283 constitute a dynamic-flying height measuring module (F measuring module) 286 for measuring the dynamic flying height Fi of the head 121.

The ΔDFHP calculation module 284 uses the dynamic flying height Fi calculated (measured) by the F calculation module 283 (F measuring module 286), as the dynamic flying height (second dynamic flying height) Fc that the head 131 has at present. Thus, the ΔDFHP calculation module 284 calculates a change ΔDFHPt in the DFH power, which corresponds to the difference (change in the dynamic flying height of the head 121) between the second dynamic flying height Fc and the first dynamic flying height Ft, i.e., target dynamic flying height. To calculate ΔDFHPt, the coefficient k is applied, in addition to Fc and Ft. Ft and k are held in the registers 261b and 261c, respectively.

The adder module 285 adds, to DFHPt, ΔDFHPt calculated by the ΔDFHP calculation module 284. The output of the adder module 285, i.e., the sum of DFHPt and ΔDFHPt, is a value DFHPc that is optimal that the DFH power must have to achieve the first dynamic flying height Ft at the time the sum is obtained. Value DFHPc is held in the register 261e. The ΔDFHP calculation module 284 and the adder module 285 constitute a DFH-power calculation module (DFHP calculation module) 287 that calculates DFHPc.

How this embodiment determines the reference DFH power and performs the calibration process will be explained below.

(A) Process of Determining the Reference DFH Power

First, the process of determining the reference DFH power during the manufacture of the HDD (more precisely, the reference DFH-power determining process performed in the heat-run test) will be explained, with reference to the flowchart of FIG. 2.

The CPU 270 controls the HDC 240, causing the head 121 to write the data of a constant frequency (single-frequency reference pattern) for measuring the dynamic flying height, in the system area 111 provided on the disk 110 (Block 301). More specifically, the data of the constant frequency is written in a prescribed track (specified track) that exists in the system area 111. The data of the constant frequency is of such type as described in the second prior-art document identified above.

The CPU 270 then causes the F measuring module 286 to measure the dynamic flying height of the head 121, which corresponds to the DFH power supplied from the heater controller 153 to the heater 122 mounted on the slider 120, while changing the value DFHPi of the DFH power (Block 302). That is, while the DFH power of value DFHPi is being supplied to the heater 122, the dynamic flying height Fi of the head 121 is measured by such a method as described in the second prior-art document.

First, the head 121 reads the data of the constant frequency from the specified track, generating a read signal. The read signal (read-back signal) thus read by the head 121 is supplied to the read amplifier 151 incorporated in the HIC 150. The read amplifier 151 amplifies the read signal, which is input to the read channel 231 provided in the read/write channel 230. The read signal is then input via the analog filter 233 to the ADC 234. The ADC 234 converts the read signal to digital data. The digital data is supplied to the digital filter 235 and waveform-equalized. In the F measuring module 286, the HS module 281 detects the amplitude Hi of the first harmonic wave and the amplitude H3 of the third harmonic wave, from the digital data thus waveform-equalized. The HS module 281 may detect the amplitudes H1 and H3 from the digital data not waveform-equalized (i.e., the output of the ADC 234), instead of from the digital data.

The F calculation module 283 provided in the F measuring module 286 performs the HRF method, calculating the dynamic flying height Fi of the head 121, which corresponds to the value DFHPi, from the amplitude H1 of the first harmonic wave and the amplitude H3 of the third harmonic wave, both detected by the HS module 281. To calculate the dynamic flying height Fi, the F calculation module 283 uses a prescribed function f(x). Variable x is the natural logarithmic value In (H1/H3) of ratio H1/H3 of the amplitude H1 of the first harmonic wave to the amplitude H3 of the third harmonic wave. That is, the F calculation module 283 calculates the dynamic flying height Fi of the head 121, which corresponds to DFHPi, by using the following equation:

Fi=f{In(H1/H3)} (2)

The data representing the dynamic flying height Fi of the head 121, which the F calculation module 283 (provided in the F measuring module 286) has calculated, is held in the register 261a. The CPU 270 reads the data representing dynamic flying height Fi, from the register 261a. The CPU 270 then stores this data in a work area provided in, for example, the RAM 260, in association with the value DFHPi of the DFH power supplied to the heater 122 at present. If the CPU 270 incorporates a memory, a part of the storage area of this memory may be used as such work area.

In Block 302, the CPU 270 repeatedly performs the above-described operation, a prescribed number of times, each time causing the heater controller 153 to change the value DFHPi of the DFH power supplied to the heater 122.

Next, the CPU 270 acquires (calculates) the change ΔDFHP in the DFH power, from the dynamic flying height Fi of the head 121, which has been measured in Block 302 and corresponds to each DFH power. The CPU 270 also acquires the change ΔF in the dynamic flying height of the head 121, which corresponds to the change ΔDFHP (Block 303). As is known in the art, the relation the dynamic flying height of the head 121 has with the DFH power can be approximated as a linear expression. Hence, the CPU 270 calculates (determines) the coefficient k representing the slope of the linear expression (i.e., the rate at which the dynamic flying height of the head 121 changes with the DFH power), by using the equation (1) given above (Block 304).

Further, the CPU 270 determines the value DFHPt of the DFH power (reference DFH power) required to achieve the target dynamic flying height (first dynamic flying height) Ft (Block 305). The value DFHPt is determined from the relation the dynamic flying height Fi of the head 121 has with the value DFHPi measured in Block 302. The CPU 270 stores Ft, k and DFHPi in the DFH management area 251 provided in the FROM 250 (Block 306).

(B) Calibration Process

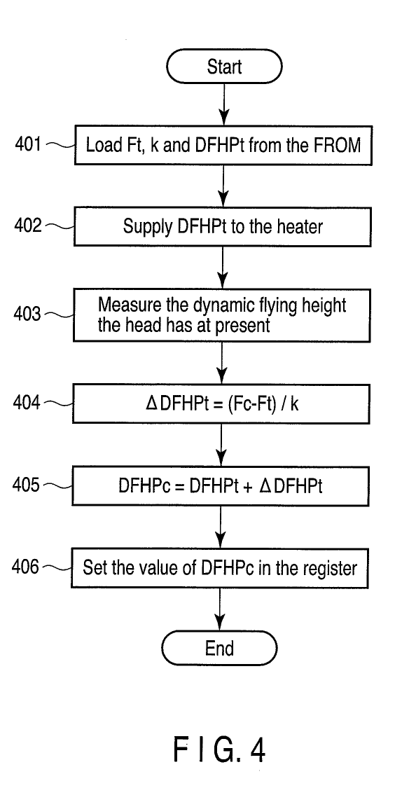

The calibration process that is performed when the HDD is activated (powered on) will be explained with reference to the flowchart of FIG. 4. The calibration process is performed in order to acquire (calculate) value ΔDFHPt by which the DFH power deviates from the reference power DFHPt that is optimal for the head 121 to have the target dynamic flying height Ft.

When the HDD is activated, an initialization process is performed to initialize the HDD. The initialization process includes the calibration process that is performed under the control of the CPU 270. In the calibration process, the CPU 270 first initializes the register file 261 stored in the RAM 260. More precisely, the CPU 270 loads Ft, k and DFHPt, all stored in the DFH management area 251 provided in the FROM 250, into the registers 261b, 261c and 261d, respectively (Block 401).

The CPU 270 then controls the heater controller 153 via the HDC 240. Controlled by the CPU 270, the heater controller 153 supplies the DFH power (i.e., reference DFH power) of the value represented by DFHPt loaded in the register 261d, to the heater 122 (Block 402). In this condition, the CPU 270 causes the F measuring module 286 to measure the dynamic flying height of the head 121, which corresponds to DFHPt, as the present dynamic flying height Fi(second dynamic flying height) (Block 403).

The condition for setting the DFH power to achieve the target dynamic flying height (Ft) of the head 121 may not change with time in the HDD of FIG. 1. If this is the case, the present dynamic flying height Fc of the head 121, which corresponds to DFHPt, is equal to Ft. On the other hand, if the condition for setting the DFH power changes with time, Fc will deviate from Ft. In other words, the optimal value for the DFH power will deviate from the reference DFH power DFHPt. This deviation (change), ΔDFHPt, is given as follows, from the equation (1):

ΔDFHPt=ΔF/k=(Fc-Ft)/k (3)

where ΔF (=Fc-Ft) is the value (change) by which the dynamic flying height Fc of the head 121 deviates from Ft when the reference DFH power (DFHPt) is supplied to the heater 122.

The ΔDFHP calculation module 284 receives the dynamic flying height Fc (second dynamic flying height) measured (calculated) by the F calculation module 283 (provided in the F measuring module 286), the target dynamic flying height Ft (first dynamic flying height) loaded (held) in the register 261b, and the coefficient k loaded in the register 261c. From these three data items, the ΔDFHP calculation module 284 calculates ΔDFHPt in accordance with the equation (3) set forth above (Block 404).

The adder module 285 receives ΔDFHPt calculated by the ΔDFHP calculation module 284 and DFHPt loaded in the register 261d. The adder module 285 adds ΔDFHPt and DFHPt, calculating DFHPc, as shown in the following equation (4) (Block 405):

DFHPC=DFHPt+ΔDFHPt (4)

DFHPC, thus calculated by the adder module 285, is the DFH power optimal for the head 121 to have the target dynamic flying height Ft (first dynamic flying height) at present. Thus, ΔDFHPt is used as a calibration value for setting (calibrating) DFHPc, i.e., the value that is optimal for the DFH power at present, on the basis of the reference DFH power determined during the manufacture of the HDD.

DFHPc calculated by the adder module 285 is set in the register 261e (Block 406). The calibration process is thus terminated. In this embodiment, the CPU 270 uses a DFH power having value DFHPc set in the register 261e until the HDD shown in FIG. 1 is turned off, as a DFH power optimal for achieving the target dynamic flying height Ft. In other words, the CPU 270 changes the DFH power the heater controller 153 should supply to the heater 122, by value ΔDFHPt calculated by the ΔDFHP calculation module 284 for the reference DFH power DFHPt.

Thus, this embodiment can perform the calibration process by measuring the dynamic flying height (Fc) only once, in order to acquire ΔDFHPt (i.e., deviation from the reference DFH power DFHPt) that is indispensable for setting the value DFHPc (=DFHPt+ΔDFHPt) that is optimal for DFH power. Hence, the calibration process can be performed at high speed in this embodiment.

In the above-described embodiment, the HRF method is applied to measure the dynamic flying height of the head 121. Nonetheless, any of the various other methods known in the art may be employed, instead. For example, the pulse-width method may be utilized, which is disclosed in the second prior-art document identified above, too. In the embodiment described above, the actuator 140 is a thermal actuator. Nevertheless, the actuator 140 may be a piezoelectric actuator or an electrostatic actuator.

Moreover, the HDC 240 need not incorporate the DFHP calculation module 282, and the CPU 270 may cause the F calculation module 283, ΔDFHP calculation module 284 and adder module 285, all provided in the DFHP calculation module 282, to perform the respective calculations assigned to them.

The various modules of the HDD described herein can be implemented as software applications, hardware and/or software modules. While the various modules are illustrated separately, they may share some or all of the same underlying logic or code.

Further, the DFH management area 251 may be provided in the storage area of a nonvolatile memory device other than the FROM 250. The disk 110, for example, can be used as such a nonvolatile memory device. In this case, the data saved in the area 251 can be prevented from being rewritten as a write request is made in the host (user), only if the area 251 is provided in, for example, the system area 111 of the disk 110.

[Modification]

In the embodiment described above, the temperature-dependency of the DFH power optimal for achieving the target dynamic flying height Ft is not taken into consideration. If the temperature-dependency must be considered, it suffices to determining the referenced DFH power repeatedly, while changing the temperature ambient to the HDD. This method can determine the temperature characteristic of DFHPt during the manufacture of the HDD. As generally known, the relation DFHPt has with temperature T can be approximated as a linear expression. A coefficient a for the linear expression that represents the temperature characteristic of DFHPt can therefore be acquired.

Assume that the DFH power has an optimal value DFHPt(T0) at a certain temperature T0 (e.g., reference temperature), and has an optimal value DFHPt(T) at temperature T. The optimal value DFHPt(T) of the DFH power is given as follows:

DFHPt(T)=DFHPt(T0)+α(T-T0) (5)

Hence, it suffices to store DFHPt(T0), α and T0 in the DFH management area 251 along with Ft and k.

The temperature ambient to the HDD may be T when the calibration process is performed. If this is the case, it suffices to load DFHPt(T) calculated by using the equation (5), into the register 261d. In view of this, DFHPt and DFHPc, may be regarded as DFHPt(T) and DFHPc(T), respectively, if necessary, in the calibration process performed in the above-described embodiment.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

What is claimed is:

1. A disk drive comprising:
an adjusting element configured to adjust a dynamic flying height of a head in accordance with a supplied power;
a measuring module configured to measure the dynamic flying height of the head;
a calculator configured to calculate a change ΔDFHPt in a reference power optimal for setting a first dynamic flying height, based on a difference between a second dynamic flying height, which has a value measured by the measuring module while the reference power is being supplied to the adjusting element, and the first dynamic flying height; and
a controller configured to change the power to be supplied to the adjusting element, by the change ΔDFHPt calculated by the calculator for the reference power.

2. The disk drive of claim 1, wherein the controller is configured to cause the calculator to calculate the change ΔDFHPt when the disk drive is activated.

3. The disk drive of claim 1, wherein the calculator is configured to calculate the change ΔDFHPt in the reference power from the following equation where k is a coefficient representing a ratio of a change in the dynamic flying height of the head to the change in the power supplied to the adjusting element:
ΔDFHPt=(second dynamic flying height−first dynamic flying height)/k.

4. The disk drive of claim 3, wherein the controller is configured to determine the coefficient k and the reference power during the manufacture of the disk drive.

5. The disk drive of claim 4, wherein the controller is configured to determine the coefficient k and the reference power from a relation between the dynamic flying height measured by the measuring module and the power.

6. The disk drive of claim 5, wherein the controller is configured to detect a change ΔF in the dynamic flying height of the head, resulting from the change ΔDFHP in the reference power, and to calculate the coefficient k from the following equation:
k=ΔF/ΔDFHP.

7. The disk drive of claim 4, further comprising a nonvolatile memory device configured to store a value of the reference power and the coefficient k.

8. A method of calibrating power necessary for setting a first dynamic flying height of a head in a disk drive, the method comprising:
supplying reference power of a predetermined value necessary for setting the first dynamic flying height to an adjusting element;
measuring a second dynamic flying height of the head while the reference power is being supplied to the adjusting element;
calculating a change ΔDFHPt in the reference power optimal for setting the first dynamic flying height, based on a difference between the second dynamic flying height measured and the first dynamic flying height; and
changing the power to be supplied to the adjusting element by the change ΔDFHPt for the reference power.

9. The method of claim 8, wherein the reference power is supplied when the disk drive is activated.

10. The method of claim 9, wherein the change ΔDFHPt is calculated from the following equation where k is a coefficient representing a ratio of a change in the dynamic flying height of the head to the change in the power supplied to the adjusting element:
ΔDFHPt=(second dynamic flying height−first dynamic flying height)/k.

11. The method of claim 10, further comprising determining the coefficient k and the reference power during the manufacture of the disk drive.

12. The method of claim 11, wherein the determining the coefficient k and the reference power during the manufacture of the disk drive includes:
measuring the dynamic flying height of the head corresponding to each value of the power, while changing the power supplied to the adjusting element;
detecting a change ΔDFHP in the power and a change ΔF in the dynamic flying height of the head, corresponding to the change ΔDFHP, from the dynamic flying height corresponding to each value of the power; and
determining the coefficient k from the change ΔDFHP in the power and the change ΔF corresponding to the change ΔDFHP.

13. The method of claim 12, wherein the determining the coefficient k and the reference power during the manufacture of the disk drive further comprises determining the value of the reference power from a relation between the dynamic flying height and the power measured.

14. The method of claim 11, further comprising storing a value of the reference power and the coefficient k in a nonvolatile memory device.
